(19) United States
(12) Patent Application Publication
(10) Pub. No.: US 2009/0216584 A1
(43) Pub. Date: Aug. 27, 2009

(54) REPAIR DIAGNOSTICS BASED ON REPLACEMENT PARTS INVENTORY

(76) Inventors: Gregory J. Fountain, Kalamazoo, MI (US); Harry M. Gilbert, Portage, MI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/038,365

(22) Filed: Feb. 27, 2008

(51) Int. Cl. G01M 17/00; G06Q 99/00

(52) U.S. Cl. 705/7; 701/35

(57) ABSTRACT

A diagnostic system for diagnosing a vehicle, includes a first memory storing in a database, dynamic sales of components of the vehicle, a signal translator that communicates with the vehicle in at least one protocol, an input device that inputs information, a processor that controls a software according to the input information from the input device and communicates with the vehicle with the signal translator, a second memory stores the software controlled by the processor, the second memory stores information transferred from the first memory including the dynamic sales data, the processor ranking a failure mode of the vehicle according to the sales data of the components of the vehicle, executing a diagnostic routine on the vehicle based on the rank order of the component, and a display unit that receives and displays diagnostic information according to ranked failure mode.

### TECHNICAL FIELD

The present disclosure relates generally to diagnostic equipment. More particularly, the present disclosure relates to diagnostic equipment having repair diagnostics based on external data.

### BACKGROUND OF THE DISCLOSURE

Onboard control computers have become prevalent in motor vehicles, but as safety, economy, and emissions requirements have continued to tighten, vehicle systems have not met the requirements set out in government regulations and the implicit demands of competitors' achievements. Successive generations of onboard control computers have acquired increasing data sensing and retention capability as the electronics have advanced.

Present external diagnostic and display apparatus, known as diagnostic tools, are commonly limited to reporting the data acquired by the onboard control computer itself. Increasingly, subtle subsystem failures in vehicles overload the ability of maintenance technicians, not simply to read the faults detected and stored by the diagnostic tools themselves, but to combine those readings with peripheral measurements and deduce corrective actions with both speed and accuracy.

Currently in the automotive industry, there are both stand alone and hand-held diagnostic testers or tools used in connection with motor vehicle maintenance and repair. For example, hand-held diagnostic tools have been used to trouble-shoot faults associated with vehicular control units. Diagnostic tools can detect faults based on Diagnostic Trouble Codes or DTCs that are set in the vehicle's onboard control computer. A DTC can be triggered and stored when there is a problem with the vehicle. A technician then retrieves the DTC using a diagnostic tool, repairs the associated problem and then deletes the DTC from the vehicle's computer.

Including and beyond diagnostic trouble codes, in general, diagnostic systems are used by technicians and professionals in virtually all industries to perform basic and advanced system testing functions. For example, in the automotive, trucking, heavy equipment and aircraft industries, diagnostic test systems provide for vehicle onboard computer fault or trouble code display as mentioned above, interactive diagnostics, multiscope and multimeter functions, and electronic service manuals. In the medical industry, diagnostic systems provide for monitoring body functions and diagnosis of medical conditions, as well as system diagnostics to detect anomalies in the medical equipment.

In many industries, diagnostic systems play an increasingly important role in manufacturing processes, as well as in maintenance and repair throughout the lifetime of the equipment or product. Some diagnostic systems are based on personal computer technology and feature user-friendly, menu-driven diagnostic applications. These systems assist technicians and professionals at all levels in performing system diagnostics on a real-time basis.

A typical diagnostic system includes a display on which instructions for diagnostic procedures are displayed. The system also includes a system interface that allows the operator to view real-time operational feedback and diagnostic information. Thus, the operator may view, for example, vehicle engine speed in revolutions per minute, or battery voltage during start cranking; or a patient's heartbeat rate or blood pressure. With such a system, a relatively inexperienced operator may perform advanced diagnostic procedures and diagnose complex operational or medical problems.

The diagnostic procedures for diagnostic systems of this sort are typically developed by experienced technical experts or professionals. The technical expert or professional provides the technical experience and knowledge required to develop complex diagnostic procedures. Thus, the efficacy of the diagnostic procedures, in particular the sequence in which the diagnostic procedures are performed, is highly dependent on the expertise of the technical expert or professional authoring the procedures.

Repair diagnostics are complex and therefore, being dependent on the expertise of individual users can cause a lack of uniformity among the repairs performed. Therefore, there is a need to have a method of making repair diagnostic using a criteria that would make diagnostics more reliable and more efficient. When there is a symptom and a plurality of paths to be checked, there needs to be method of choosing the best path for diagnostics.

### SUMMARY OF THE DISCLOSURE

The foregoing needs are met, to a great extent, by the present disclosure, wherein in one aspect a technique and apparatus are provided that will allow a technician to use a diagnostic system to determine the nature of a problem, with the ability to rank the failure mode according to external data.

In accordance with one aspect of the present disclosure, a diagnostic system for diagnosing a vehicle, including a first memory storing in a database, dynamic sales of components of the vehicle, a signal translator that communicates with the vehicle in at least one protocol, an input device that inputs information, a processor that controls a software according to the input information from the input device and communicates with the vehicle with the signal translator, a second memory stores the software controlled by the processor, the second memory stores information transferred from the first memory including the dynamic sales data, the processor ranking a failure mode of the vehicle according to the sales data of the replacement components of the vehicle, executing a diagnostic routine on the vehicle based on the rank order of the component, and a display unit that receives and displays diagnostic information according to ranked failure mode.

The diagnostic system can also include the determination of the failure mode by the processor includes a criteria of cost of the component. The diagnostic system can also include the determination of the failure mode by the processor includes a criteria of difficulty of repair for the component. The sales statistics of replacement components affect the ranking of the failure mode test, which are linked to the failed component, within an overall list of a plurality of failure mode tests.

The diagnostic system can also include the use of inventory of replacement parts being stored in the database for determination of the rank by the processor. The diagnostic system can also include ranking all the component paths for diagnosis for a particular symptom being diagnosed.

The diagnostic system can also include factoring recall information with the sales data. The diagnostic system can also include the database being sorted according to the make, model and year of the vehicle for transfer to the second memory. The diagnostic system can also include linking inventory replacement parts data and the sales data of the replacement part with the failure mode.

The diagnostic system can also include each one of the first and second memory, further including a volatile memory unit and a non-volatile memory unit, the non-volatile memory unit storing the sales data. The diagnostic system can also include the processor accepting a selection of the ranking according to the criteria inputted through the input device.

The diagnostic system can also include a housing encasing the signal translator, the input device, an input unit, the processor, the second memory, and the display unit for storing and processing the ranked diagnostic procedure. The diagnostic system can also include a connector interface that connects the signal translator with a vehicle interface through one of a wired and wireless link to allow for recording of the diagnostic data of the vehicle.

In another aspect of the disclosure, a method of operating a diagnostic tool for a vehicle, includes linking the diagnostic tool with a diagnostic computer of the vehicle through a data link connector of the vehicle, communicating with the diagnostic computer of the vehicle in a communication protocol, monitoring external data related to a replacement part of the vehicle, determining a high probability of a failure mode based on the external data, ranking the failure mode according to the probability of the failure mode, determining whether the failure mode with the highest rank is the cause of the symptom in the vehicle, and determining whether the failure mode with the next highest rank is the cause of the symptom in the vehicle when the highest ranked failure mode is not the cause of the symptom.

In another aspect of the disclosure, a diagnostic system for diagnosing a vehicle, includes a first memory means for storing in a database, external data of the components of the vehicle, a signal translator means for communicating with the vehicle in at least one protocol, an input means for inputting information from the first memory means and an external source, a processor means that controls a software according to the input information from the input means and communicates with the vehicle with the signal translator means, a second memory means storing the software controlled by the processor means, the second memory means stores information transferred from the first memory means including the external data, the processor ranking a failure mode of the vehicle according to the external data of the components of the vehicle, executing a diagnostic routine on the vehicle based on the rank order of the component, and a display unit that receives and displays diagnostic information according to ranked failure mode.

There has thus been outlined, rather broadly, certain embodiments of the disclosure in order that the detailed description thereof herein may be better understood, and in order that the present contribution to the art may be better appreciated. There are, of course, additional embodiments of the disclosure that will be described below and which will form the subject matter of the claims appended hereto.

In this respect, before explaining at least one embodiment of the disclosure in detail, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

### BRIEF DESCRIPTION OF THE DRAWINGS

FIG. 1 is a front view illustrating a connection between a vehicle and a diagnostic tool or personal computer according to an embodiment of the disclosure.

FIG. 2 is a flow diagram of the diagnostics determination based on external data.

FIG. 3 is an example of the diagnostic system with a database for external data.

FIG. 4 is a block diagram of the computer of FIG. 1.

FIG. 5 is a front view of the diagnostic tool of FIG. 1.

FIG. 6 is a block diagram of the components of the diagnostic tool of FIG. 5.

### DETAILED DESCRIPTION

The disclosure will now be described with reference to the drawing figures, in which like reference numerals refer to like parts throughout. An embodiment in accordance with the present disclosure provides an apparatus and method that will allow a user, such as a technician, to use diagnostic equipment to determine the nature of a problem, and the diagnostic equipment for repair diagnostics based on replacement parts inventory. The diagnostic equipment can include, for example, but not limited to a diagnostic tool or a personal computer, or other type of computing device capable of diagnostics upon a vehicle.

Data gathered and analyzed specific to replacement parts inventory provides a basis for a form of case-based reasoning. Filtering of this data would indicate high rates of parts failure specific to a model or system. Assembling this data in a format of most likely failure modes would offer a basis for diagnosis of a given symptom even though a technician may not be familiar with that model or system.

Rather than using internally collected data that may take time to accumulate, the present disclosure includes the use of an external source of data to derive statistical data regarding the failure modes of vehicles. Therefore, as shown below, the use of sales data, for example, allows the likelihood of failure mode occurring to be determined based on historical sales of parts.

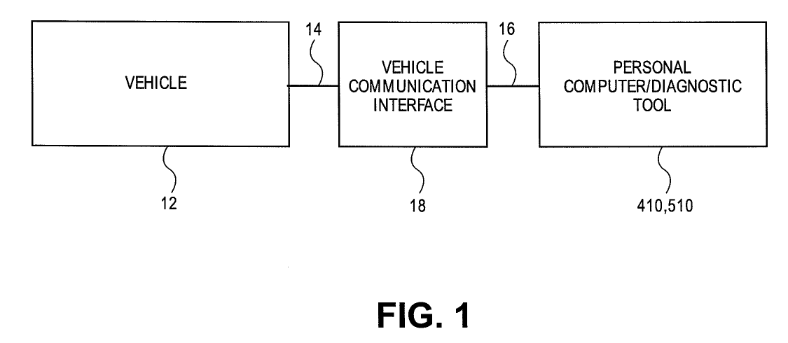

Referring to FIG. 1, a vehicle 12 is shown connected to a personal computer 410 or a dedicated diagnostic tool 510 via a vehicle communication interface 18. The first connection 14 between vehicle 12 and the vehicle communication interface 18, and the second connection 16 between the vehicle communication interface 18 and the personal computer/diagnostic tool 410 and 510 can be either wired or wireless.

Applicable communications with the host, such as a vehicle 12 connected to the unit, can be maintained during all functions of the vehicle during diagnostics. The connections 14 and 16 can include a wired connection such as through a RS232 port, USB (Universal Serial Bus), Ethernet cable. However, the connections 410 and 510 can also be wireless using protocols such as BLUETOOTH, IEEE 802.11x, wireless USB, other types of wireless Ethernet protocols, etc.

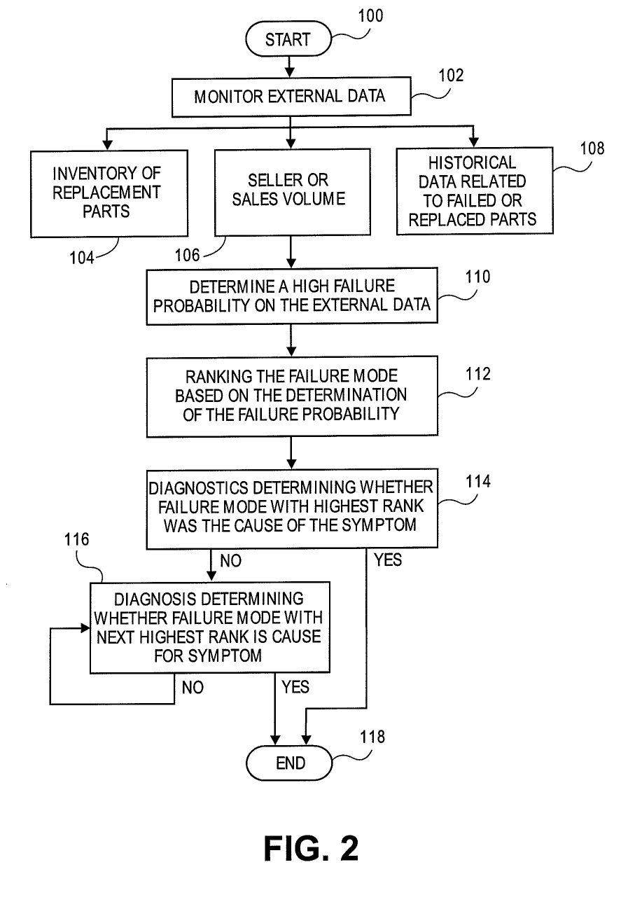

Referring to FIG. 2, the inventory of replacement parts, seller or sales volume for a parts manufacturer would be monitored for the frequency of sales of replacement parts specific to a particular model or system. In step 102, the system can monitor for external data 102. The external data can include the inventory of replacement parts 104, seller to sales volume data 106, or another type of historical data related to the failed or replaced parts 108. For example, a high frequency of sales of a specific component would indicate a high failure mode. Therefore, the external data 102 including the data from the inventory of replacement parts data 104, the seller or sales volume data 106 or the historical data related to the failed or replaced parts 108, an analysis is made to determine the high failure mode 110. Diagnostics would be then be directed towards this failure mode as a likely scenario that should be investigated with priority 112. Therefore, the failure mode that is noted based on the external data is given a priority or rank.

Then, the diagnostic system determines whether the failure mode with the highest priority or rank was the cause of the symptom 114. If it is, then the procedure ends 118. However, should diagnostics prove that this failure mode was not the cause of the symptom; subsequent diagnostics could then be directed towards the next highest frequency component failure 116. This process of checking the next highest frequency of component failure is repeated until the failure mode is the cause of the symptom.

Alternatively, the diagnostics can be selected to still check whether the next highest ranked failure mode is the cause of the symptom even when there is a determination of a previous failure mode to be the cause of the symptom in order to cover more than one component being the cause of the symptom.

The components can also be grouped in terms of the type of component being determined. For example, not only a single resistor can be looked at in an electrical system, but the array of resistors in a certain circuit of the system. Different combinations can be made in the determination of the failure mode. The example of a single part is only an example and the disclosure is not limited to a single part, but can be a plurality of parts.

The dynamic gathering of inventory data would assure that failure modes could change as a model ages or environmental changes takes their toll on the serviceability of a component. The inventory can include a historical information of the inventory from a specific range or period of time, but the data can be static information for the period of time, but preferably dynamic information for the period including the time the diagnostics are being performed, or as close as possible to the time the diagnostics are performed. The historical information can be stored in a memory of the diagnostic tool 510 or personal computer 410, or other diagnostic equipment. The dynamic data can be uploaded through a communication port in the diagnostic tool 510 or the personal computer 410 via the Internet, or through an external memory input or transfer through a communication port.

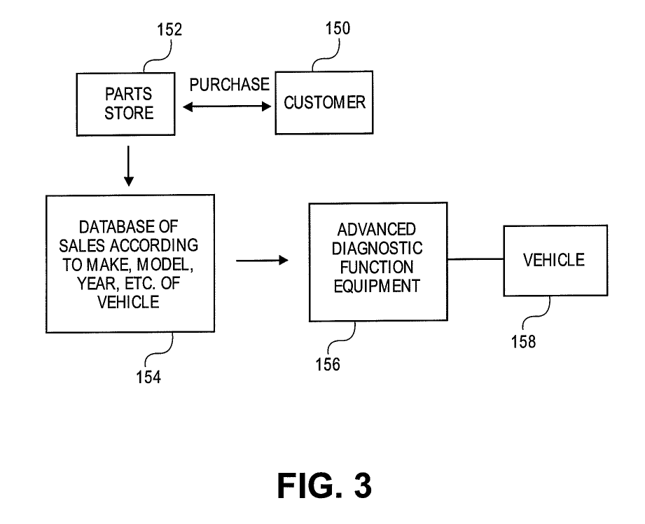

Referring to FIG. 3, an example of diagnostic system is shown. The diagnostic based on the method of the disclosure becomes more efficient based on the use of the external data. The parts inventory sales, for example is linked with the diagnostics. If the diagnostics is based on failure mode, then the failure mode is linked with the dynamic historical sales data. If the diagnostic is based on another mode, then that mode would be linked. In an example, a system with 5 or 6 components has a trouble code. When there is a check of those 5 or 6 components, then there would at least 5 failure mode paths. To be more efficient, one can use the parts inventory to figure out the most likely path for diagnosis. The information would be integrated back into the advanced diagnostic function equipment 156 that is connected to the vehicle 158 for diagnostics.

For example, the customer 150 can purchase a throttle position sensor from a parts store 152, and the information is then placed in the external database 154. In the database 154, the frequency of sales, model, application fields can be stored. The fields of sales, model and application are linked with the information received form the parts store 152.

If a high number of sales based on the model application is shown for the throttle position sensor, then it would weighted with an appropriate rank higher than a component with a lower number of sales for a period of time. The throttle position sensor can be applied to a plurality of vehicles, but if we know the model that the throttle position sensor applies to, then that information would help in placing a weight on the diagnostic to be determined.

If the equipment 156 or other system sees a high number for the sales information, then such information is helpful in determining the ranking. Additionally, if the vehicle application or model application is known, and then there can be determined a high failure mode for certain model application, the information can be used to provide the priority of the diagnostics. If we have a throttle position sensor and ground signal processor being looked at then the throttle position sensor can be weighted higher than the other parts involved. The most likely item that needs testing is found by using the database with the sales data 154.

Alternative to the sales data, other historically based data showing the failure of the component, as shown above, can be used. Recall information can also be used, for example, instead or in addition to the sales data in the database 154. The database 154 can be sorted out based on the frequency or other criteria to suggest the failure rate of the component.

One can also include the variable of the actual cost of the component to be factored into the prioritizing of the component. For example, if a first component costs 500 dollars and a second unit costs 50 cents, one may factor in the cost with regard to the priority of the diagnostics. This is because a user may want to replace a 50 cent part rather than a 500 dollar part. Therefore, even though the 500 part may have a greater frequency, the 50 cent part if it is the second most frequent, for example, can be checked first before the 500 dollar part. A plurality of combination of criteria for the ranking of the component can be used. Therefore, additional factors can be included in the ranking. The ranking or weighting can be customized dependent on the customer or the user. For example, one customer can be more concerned with cost and another can be concerned with the time elapsed of the diagnosis.

The sales, price, and quantity can factored into the database 154 for determination of the rank by the advanced diagnostic equipment 156. The difficulty of the repair can also be factored in. For example, if the component is buried in the dashboard of the vehicle, then the difficulty would be higher and the rank would then be lower for the part, even though the frequency of the sale was higher than another part. The sales frequency and the difficulty of the repair can be factored in at any percentage. For example, the difficulty of the repair can be 25% of the rank, but the sales data can be 75% of the rank. Therefore, the ranking can include the difficulty of the repair as additional criteria involved in addition to the sales data. Therefore, the component can be linked to a certain or any type of pattern failure.

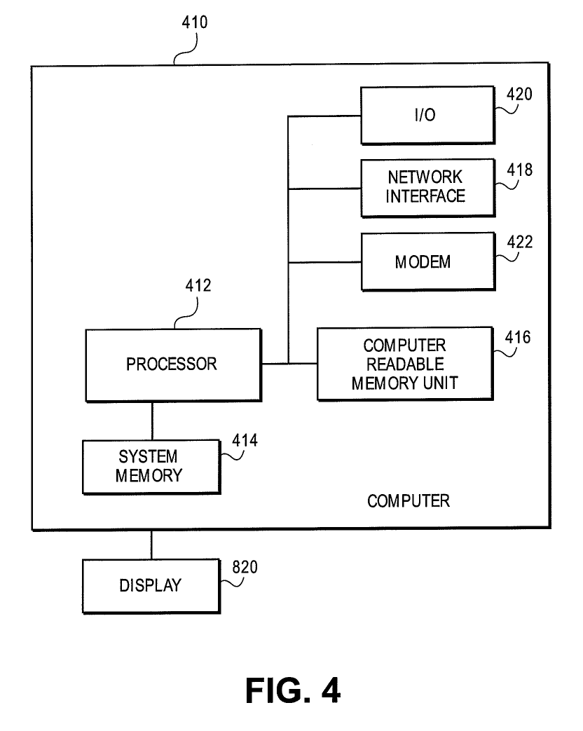

Referring to FIG. 4, an example of the computer 410 of FIG. 1, but not limited to this example of the computer 410, that can read computer readable media that includes computer-executable instructions of the disclosure. The computer 410 includes a processor 412 that uses the system memory 414 and a computer readable memory device 416 that includes certain computer readable recording media. A system bus connects the processor 412 to a network interface 418, modem 422 or other interface that accommodates a connection to another computer or network such as the Internet. The system bus may also include an input and output (I/O) interface 420 that accommodate connection to a variety of other devices. Furthermore, the computer 410 can output through, for example, the I/O 420, data for display on a display device 820.

The disclosure or parts thereof can be realized as computer-executable instructions in computer-readable media. The computer-readable media includes all possible kinds of media in which computer-readable data is stored or included or can include any type of data that can be read by a computer or a processing unit. The computer-readable media include for example and not limited to storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that may be local or remote to the processing system. The present disclosure can include the computer-readable medium having stored thereon a data structure including a plurality of fields containing data representing the techniques of the disclosure.

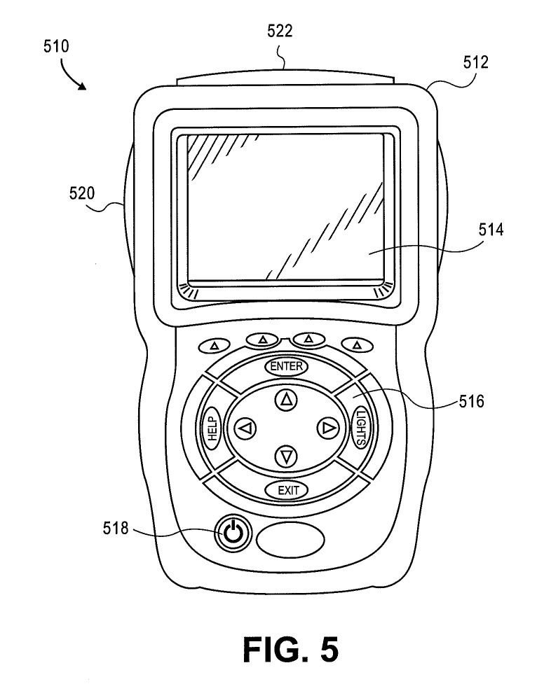

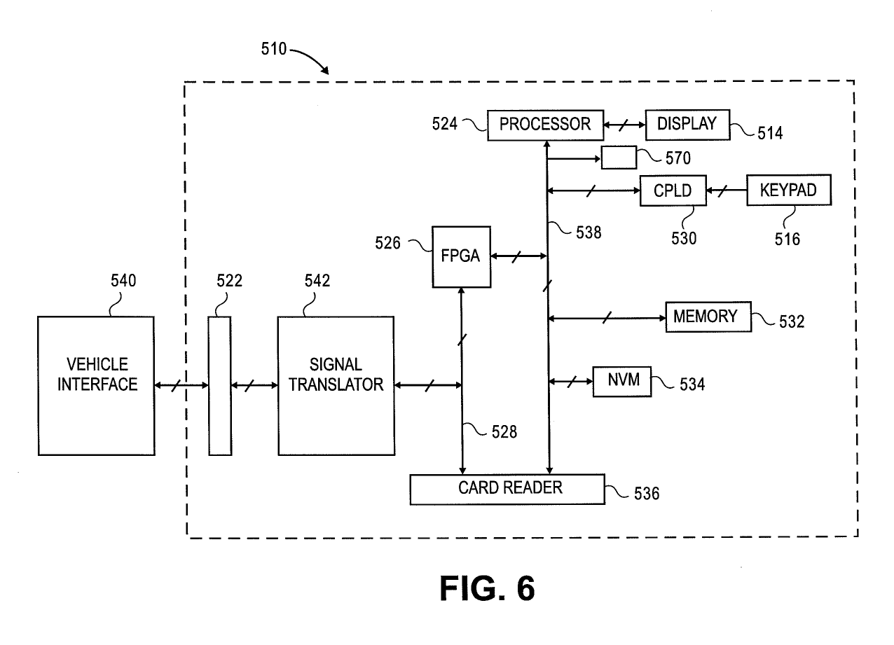

FIGS. 5-6 show the details of the diagnostic tool 510 of FIG. 1. Manufacturers have programmed their vehicle onboard computers with complicated methods of detecting a variety of problems. Further, the United States Environmental Protection Agency has mandated that DTCs be set where there are emissions related problems with the vehicle using the Onboard Diagnostic II System, also known as the OBD II system.

However, there are still problems of using the diagnostic tool since there are limitations in troubleshooting the actual cause of the functional anomaly of the diagnostic tool. A user is forced to look directly at the diagnostic tool's limited display that may display only the DTC or simple indicator of function being performed, and a message indicating a communication failure.

In an embodiment of the disclosure, the diagnostic tool will run an application that accommodates the tool recording the cable used, the exact vehicle configuration that was entered, records communication transmissions and responses, hardware configuration, etc. If the user of the diagnostic tool is in case where the tool does not respond as anticipated, the user can indicate such information and communicate such information to a technical service line for interpretation. The information will then help determine if the user had incorrectly configured the tool for the vehicle (incorrect cable, wrong information entered, etc.). Automation of some or the entire process can also be performed.

FIG. 5 is a front view illustrating a diagnostic tool 510 according to an embodiment of the disclosure. The diagnostic tool 510 can be any computing device, for example, the NEMISYS or GENISYS diagnostic tool from Service Solutions (part of the SPX Corporation) or other diagnostic tool. The diagnostic tool 510 includes a housing 512 to encase the various components of the diagnostic tool 510, such as a display 514, a user interface 516, a power button 518, a memory card reader 520 and a connector interface 522. The display 514 can be any type display, including, for example, but not limited to, a liquid crystal display (LCD), organic light emitting diode (OLED), field emission display (FED), electroluminescent display (ELD), etc. In addition, the LCD, for example, can be touch screen that both displays and performs the additional task of interfacing between the user and the diagnostic tool 510. The user interface 516 allows the user to interact with the diagnostic tool 510, in order to operate the diagnostic tool as the user prefers. The user interface 516 can include function keys, arrow keys or any other type of keys that can manipulate the diagnostic tool 510 in order to operate the diagnostic tool through the software. The user interface or input device 516 can also be a mouse or any other suitable input device for the user interface 516, including a keypad, touchpad, etc. The user interface 516 can also include keys correlating to numbers or alphanumeric characters. Moreover, as mentioned above, when the display 514 is touch sensitive, the display 514 can supplement or even substitute for the user interface 516. The power key or button 518 allows the user to turn the power to the diagnostic tool 510 on and off, as required.

A memory card reader 520 can be a single type card reader, such as, but not limited to, a compact flash card, floppy disk, memory stick, secure digital, flash memory or other type of memory. The memory card reader 520 can be a reader that reads more than one of the aforementioned memory such as a combination memory card reader. Additionally, the card reader 520 can also read any other computer readable medium, such as CD (compact disc), DVD (digital video or versatile disc), etc.

The connector interface 522 allows the diagnostic tool 510 to connect to an external device, such as, but not limited to, an ECU (electronic control unit) of a vehicle, a computing device, an external communication device (such as a modem), a network, etc. through a wired or wireless connection. Connector interface 522 can also include connections such as a USB (universal serial bus), FIREWIRE (Institute of Electrical and Electronics Engineers (IEEE) 1394), modem, RS232, RS48J, and other connections to communicate with external devices, such as a hard drive, USB drive, CD player, DVD player, or other computer readable medium devices.

FIG. 6 is a block diagram of the components of a diagnostic tool 510. In FIG. 6, the diagnostic tool 10, according to an embodiment of the disclosure, includes a processor 524, a field programmable gate array (FPGA) 526, a first system bus 528, the display 514, a complex programmable logic device (CPLD) 530, the user interface 516 in the form of a keypad, a memory subsystem 532, an internal non-volatile memory (NVM) 534, a card reader 536, a second system bus 538, the connector interface 522, and a selectable signal translator 542. A vehicle communication interface 540 is in communication with the diagnostic tool 510 through connector interface 522 via an external cable. The connection between the vehicle communication interface 540 and the connector interface 522 can also be a wireless connection such as BLUETOOTH, infrared device, wireless fidelity (WiFi, e.g. 802.11), etc.

The selectable signal translator 542 communicates with the vehicle communication interface 540 through the connector interface 522. The signal translator 542 conditions signals received from a motor vehicle control unit through the vehicle communication interface 540 to a conditioned signal compatible with the diagnostic tool 510. The translator 542 can communicate with, for example, the communication protocols of J1850 signal, ISO 9141-2 signal, communication collision detection (CCD) (e.g., Chrysler collision detection), data communication links (DCL), serial communication interface (SCI), S/F codes, a solenoid drive, J1708, RS232, controller area network (CAN), or other communication protocols that are implemented in a vehicle.

The circuitry to translate a particular communication protocol can be selected by the FPGA 526 (e.g., by tri-stating unused transceivers) or by providing a keying device that plugs into the connector interface 522 that is provided by diagnostic tool 510 to connect diagnostic tool 510 to vehicle communication interface 540. Translator 542 is also coupled to FPGA 526 and the card reader 536 via the first system bus 528. FPGA 526 transmits to and receives signals (i.e., messages) from the motor vehicle control unit through the translator 542.

FPGA 526 is coupled to the processor 524 through various address, data and control lines by the second system bus 538. FPGA 526 is also coupled to the card reader 536 through the first system bus 528. Processor 524 is also coupled to the display 514 in order to output the desired information to the user. The processor 524 communicates with the CPLD 530 through the second system bus 538. Additionally, the processor 524 is programmed to receive input from the user through the user interface 516 via the CPLD 530. The CPLD 530 provides logic for decoding various inputs from the user of diagnostic tool 510 and also provides the glue-logic for various other interfacing tasks.

Memory subsystem 532 and internal non-volatile memory 534 are coupled to the second system bus 538, which allows for communication with the processor 524 and FPGA 526. Memory subsystem 532 can include an application dependent amount of dynamic random access memory (DRAM), a hard drive, and/or read only memory (ROM). Software to run the diagnostic tool 510 can be stored in the memory subsystem 532. The internal non-volatile memory 534 can be, but not limited to, an electrically erasable programmable read-only memory (EEPROM), flash ROM, or other similar memory. The internal non-volatile memory 534 can provide, for example, storage for boot code, self-diagnostics, various drivers and space for FPGA images, if desired. If less than all of the modules are implemented in FPGA 526, the non-volatile memory 534 can contain downloadable images so that FPGA 526 can be reconfigured for a different group of communication protocols.

Although an example of the repair diagnostics based on replacement parts inventory is illustrated, it will be appreciated that other techniques for providing the repair diagnostics can be performed based on other criteria other than replacement parts inventory, including for example other historical data of the vehicle. Also, the repair diagnostics are useful to diagnose a vehicle and provide such information to the user in an efficient manner, taking into account the variables involved in the diagnostics.

The present disclosure provides an manner of using external source data to derive a statistical data regarding the failure modes of vehicles, for example. The use of sales data allows the likelihood of a failure mode occurring to be determined based on historical sales of parts. Other external data can also be used beyond the sales data.

Therefore, the method and apparatus of the disclosure provide enhanced diagnostics with a more efficient method that can factor in form a plurality of criteria set by a user. The method is more efficient by using external historical data to choose the order of performing diagnostic routines to find the cause the cause of the symptom of vehicle.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed is:

1. A diagnostic system for diagnosing a vehicle, comprising:
a first memory storing in a database, dynamic sales of components of the vehicle;
a signal translator that communicates with the vehicle in at least one protocol;
an input device that inputs information;
a processor that controls a software according to the input information from the input device and communicates with the vehicle with the signal translator;
a second memory stores the software controlled by the processor, the second memory stores information transferred from the first memory including the dynamic sales data, the processor ranking a failure mode of the vehicle according to the sales data of the components of the vehicle, executing a diagnostic routine on the vehicle based on the rank order of the component; and
a display unit that receives and displays diagnostic information according to ranked failure mode.

2. The diagnostic system of claim 1, further comprising the use of inventory of replacement parts being stored in the database for determination of the rank by the processor.

3. The diagnostic system of claim 1, further comprising ranking all the component paths for diagnosis for a particular symptom being diagnosed.

4. The diagnostic system of claim 1, further comprising factoring recall information with the sales data.

5. The diagnostic system of claim 1, wherein the database being sorted according to the make, model and year of the vehicle for transfer to the second memory.

6. The diagnostic system of claim 1, further comprising linking inventory replacement parts data and the sales data of the replacement part with the failure mode.

7. The diagnostic system of claim 1, wherein each one of the first and second memory, further comprising a volatile memory unit and a non-volatile memory unit, the non-volatile memory unit storing the sales data.

8. The diagnostic system of claim 1, wherein the processor accepts a selection of the ranking according to the criteria inputted through the input device.

9. The diagnostic system of claim 1, further comprising a housing encasing the signal translator, the input device, an input unit, the processor, the second memory, and the display unit for storing and processing the ranked diagnostic procedure, the first memory being located remotely from the housing.

10. The diagnostic system of claim 1, further comprising a connector interface that connects the signal translator with a vehicle interface through one of a wired and wireless link to allow for recording of the diagnostic data of the vehicle.

11. A method of operating a diagnostic tool for a vehicle, comprising:
linking the diagnostic tool with a diagnostic computer of the vehicle through a data link connector of the vehicle;
communicating with the diagnostic computer of the vehicle in a communication protocol;
monitoring external data related to a replacement part of the vehicle;
determining a high failure mode based on the external data;
ranking the failure mode according to the probablility of the failure mode;
determining whether the failure mode with the highest rank is the cause of a symptom in the vehicle; and
determining the whether the failure mode with the next highest rank is the cause of the symptom in the vehicle when the highest ranked failure mode is not the cause of the symptom.

12. The method of claim 11, further comprising the use of inventory of replacement parts being stored in the database for determination of the rank by the processor as the external data.

13. The method of claim 11, further comprising ranking all the component paths for diagnosis for a particular symptom being diagnosed, and the external data including at least one of a sales data, inventory of replacement part, and recall information for the component.

14. The method of claim 11, further comprising factoring recall information with the sales data as the external data.

15. The method of claim 11, wherein the database is sorted according to the vehicle history, make, model and year of the vehicle for transfer to the second memory.

16. The method of claim 11, further comprising linking inventory replacement parts data and the sales data of the replacement part with the failure mode.

17. A diagnostic system for diagnosing a vehicle, comprising:
a first memory means for storing in a database, external data of the components of the vehicle;
a signal translator means for communicating with the vehicle in at least one protocol;
an input means for inputting information from the first memory means and an external source;
a processor means that controls a software according to the input information from the input means and communicates with the vehicle with the signal translator means;
a second memory means storing the software controlled by the processor means, the second memory means stores information transferred from the first memory means including the external data, the processor ranking a failure mode of the vehicle according to the external data of the components of the vehicle, executing a diagnostic routine on the vehicle based on the rank order of the component; and
a display unit that receives and displays diagnostic information according to ranked failure mode.

18. The diagnostic system of claim 17, wherein the ranking of the failure mode by the processor means includes a criteria of cost of the component, and the external data includes inventory of the replacement component.

19. The diagnostic system of claim 17, wherein the ranking of the failure mode by the processor means includes a criteria of difficulty of repair for the component, and the external data includes the sales volume of the components.

20. The diagnostic system of claim 17, further comprising the use of inventory of replacement parts being stored in the database for determination of the rank by the processor means.

21. The diagnostic system of claim 17, further comprising ranking all the component paths for diagnosis for a particular symptom being diagnosed.
